(19) United States
(12) Patent Application Publication
(10) Pub. No.: US 2013/0025205 A1
(43) Pub. Date: Jan. 31, 2013

(54) CONFINED SPACE CONTROL COVER

(71) Applicant: Thomas Jefferson Porter, IV, League City, TX (US)

(72) Inventor: Thomas Jefferson Porter, IV, League City, TX (US)

(21) Appl. No.: 13/360,696

(22) Filed: Jan. 28, 2012

Related U.S. Application Data
(63) Continuation of application No. 13/220,644, filed on Aug. 29, 2011.
(60) Provisional application No. 61/511,523, filed on Jul. 25, 2011.

(51) Int. Cl. E06B 7/28; E05B 65/00

(52) U.S. Cl. 49/70; 160/127

(57) ABSTRACT

A confined space control cover that covers a man-way to a confined space area that includes a polyester base cover and an attachment perimeter orifice that covers the man-way, a heavy nylon strapping with two ends that is utilized to secure the confined space control cover over the man-way and a plurality of steel eyelets that are disposed on both ends of the strapping. A lock is placed through the eyelets on both ends to secure the control cover to the man-way. The control cover also includes a warning sign disposed on the front of the base cover to prevent persons from entering the confined space area and a maintenance tag that is attached to the strapping or cable and lock to indicate maintenance activity performed near or within the confined space area or man-way.

This patent application claims priority to U.S. Provisional Application No. 61/511,523 filed on Jul. 25, 2011 which was the basis and priority of U.S. Non-provisional application Ser. No. 13/220,644 filed Aug. 29, 2011, both the disclosures of which are incorporated herein by reference in its entirety. The present application is a continuation of US non-provisional application 13/220,644 filed Aug. 29, 2011.

### TECHNICAL FIELD & BACKGROUND

There is currently a plurality of confined space control covers available that address confined space areas. Even with the usage of the confined space control covers that are currently available, there are still hundreds of fatalities and injuries that occur in the chemical and refining industries as well as other heavy industries. Also, these confined space control covers are being manipulated and removed by unauthorized personnel. These individuals are sometimes entering the confined space without the proper authorization and are becoming casualties or persons with serious injuries. With the proper usage of our lockable covers, any and all individuals would have to get authorization from the key holder prior to entering the space. In most cases, the key holder is the atmospheric tester and/or responsible party for the confined space being secured and locked-out.

The present invention relates to a control covering. More specifically, the present invention relates to a confined space control cover.

It is an object of the present invention to provide a confined space control cover that is placed and securely locked over any confined space man-way that is on a tower, a vessel, a tank or other confined space control location or area.

It is an object of the present invention to provide a confined space control cover that can be locked and secured until any testing (including atmospheric testing) is done.

It is an object of the present invention to provide a confined space control cover that eliminates any possibility of an individual being able to break the plain of a confined space.

What is really needed is a confined space control cover that is placed and securely locked over any confined space man-way that is on a tower, a vessel, a tank or other confined space control location or area that can be locked and secured until any testing (including atmospheric testing) is done that eliminates any possibility of an individual being able to break the plain of the confined space.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates an environmental front perspective view of a confined space control cover, in accordance with one embodiment of the present invention.

FIG. 1B illustrates an environmental side perspective view of a confined space control cover, in accordance with one embodiment of the present invention.

FIG. 1C illustrates a side view of a cable with a locking device of a confined space control cover, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

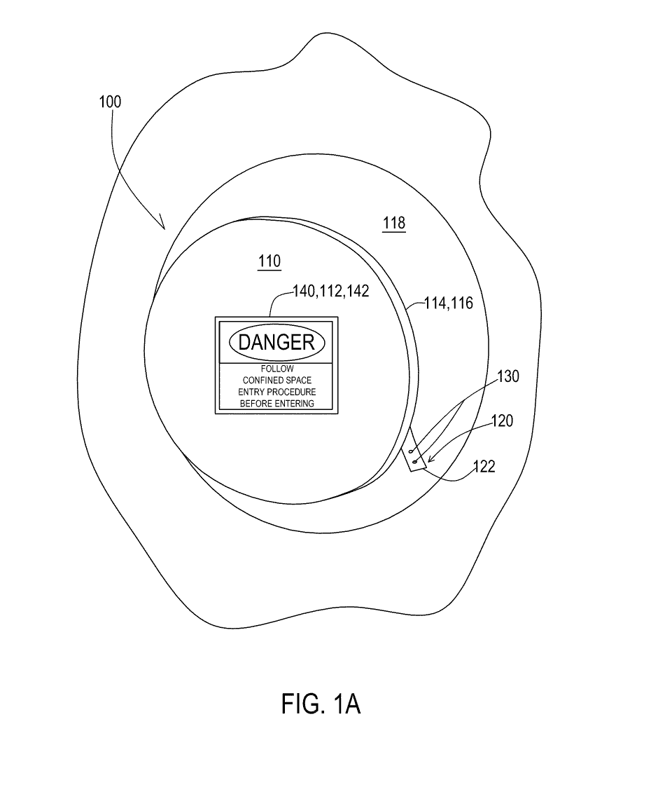

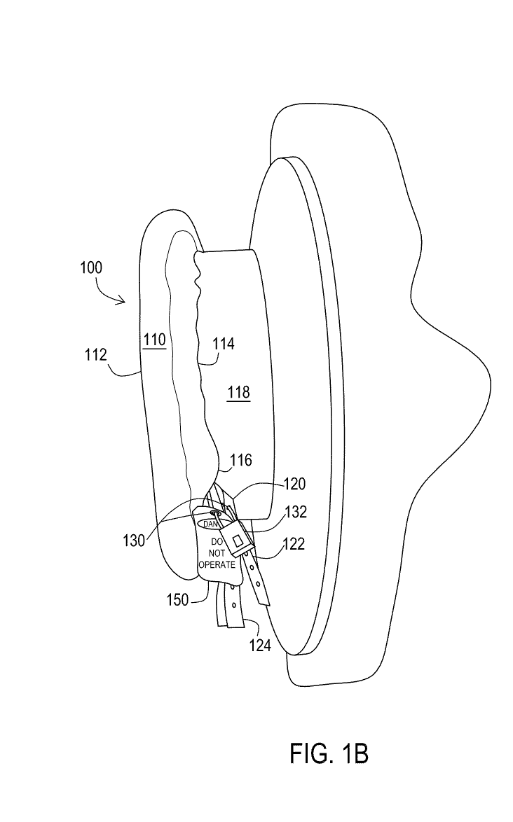

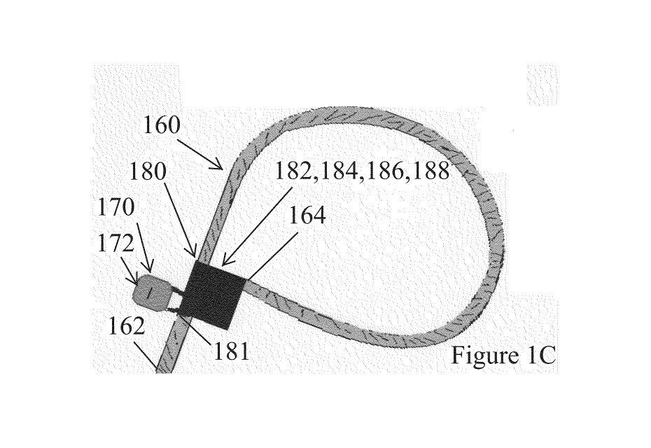

FIG. 1A illustrates a front perspective view of a confined space control cover 100, in accordance with one embodiment of the present invention. The confined space control cover 100 includes a base cover 110, a strapping 120, a plurality of eyelets 130 and a warning sign 140.

The base cover 110 with a front 112, a rear attachment opening 114 and an attachment perimeter orifice 116 covers a man-way 118 to warn and indicate persons in the surrounding area that a confined space area (not shown) is secured and locked-out. The man-way 118 leads directly to the confined space area. The base cover 110 is made of chemical resistant and breathable polyester fabric although the base cover 110 can be made of other suitable types of fabric and material as well. The strapping 120 is made of heavy nylon material that is utilized to secure the confined space control cover 100 over the man-way 118. The strapping 120 is placed through the attachment perimeter orifice 116 with both ends 122,124 being exposed outside the base cover 110. The strapping 120 can also be made of other suitable material as well. The eyelets 130 are disposed on both ends 122,124 (FIG. 1 B) of the strapping 120 to accommodate a lock 132 (FIG. 1B) that is utilized to secure both ends 122,124 of the strapping 120 around and over the man-way 118. The eyelets 130 are made of steel although the eyelets 130 can be made of any other suitable material as well. The warning sign 140 is typically disposed on the front 112 of the base cover 110, although the warning sign 140 can be disposed anywhere on the base cover 110. The warning sign 140 is typically an occupational safety and health administration or OSHA or other safety regulatory agency sign 142 although the warning sign 140 can be any suitable safety warning sign. More specifically, the warning sign 140 says “DANGER CONFINED SPACE AREA” or other suitably related confined space warning sign wording.

FIG. 1B illustrates a side perspective view of a confined space control cover 100, in accordance with one embodiment of the present invention.

The confined space control cover 100 further includes a maintenance tag 150. The maintenance tag 150 is attached to the strapping 120 to provide an additional warning to one or more persons near or within the confined space area or man-way 118.

FIG. 1C illustrates a side view of a cable 160 with a lock 170 of a confined space control cover 100, in accordance with one embodiment of the present invention. The cable 160 includes a proximal end 162 and a distal end 164 and FIG. 1C further illustrates a lock 170 and a locking mechanism 180.

The cable 160 with a lock device 170 can be utilized to secure the confined space control cover 100 around and over the man-way 118 as illustrated in FIG. 1A. The cable 160 with a lock 170 is utilized in a similar manner as the strapping 120 previously described and illustrated in FIG. 1A and its description. The cable 160 is placed through the attachment perimeter orifice 116 with the proximal and distal ends 162,164 being exposed outside the base cover 110. The cable 160 can be made of stainless steel, braided wire or any other suitable material. The proximal and distal ends 162,164 of the cable 160 are secured together within the locking mechanism 180 to accommodate a lock 170 (FIG. 1B) that is utilized to secure the cable 160 around and over the man-way 118. The locking mechanism 180 can be made of a pair of plastic stops 182 inside of a housing 184 that press firmly against the cable 160 when the locking mechanism 180 is unengaged. The locking mechanism 180 can be made of metal, plastic or other suitable material and includes a spring 186 that exerts pressure on the pair of stops 182 which allows the cable 160 to move exclusively one way and lock itself in place when retracting. The locking mechanism 180 also houses a trigger mechanism 188 that releases the spring 186 and allows the cable 160 to move inwardly or outwardly. A molded hole 181 is disposed on the locking mechanism 180 to accommodate a lock 170 to secure the locking mechanism 180 so that the spring 186 cannot be actuated. The lock 170 can be a standard lock and key 172 type of lock, a combination lock or any other suitable type of lock.

The confined space control cover is placed and securely locked over any confined space man-way that is on a tower, a vessel, a tank or other confined space control location or area that can be locked and secured until any testing (including atmospheric testing) is done that eliminates any possibility of one or more persons being able to break the plane of the confined space.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A confined space control cover that covers a man-way to a confined space area, comprising:
a base cover with a front, a rear attachment opening and an attachment perimeter orifice that covers said man-way;
a strapping with two ends that is utilized to secure said confined space control cover over said man-way;
a plurality of eyelets that are disposed on said both ends of said strapping; and
a warning sign disposed on said front of said base cover to warn and prevent one or more persons from entering said confined space area.

2. The control cover according to claim 1, wherein said base cover is made of chemical resistant and breathable fabric.

3. The control cover according to claim 1, wherein said strapping is made of heavy nylon material.

4. The control cover according to claim 1, wherein said eyelets accommodate a lock that is utilized to secure said both ends of said strapping around and over said man-way.

5. The control cover according to claim 1, wherein said warning sign is an OSHA sign.

6. The control cover according to claim 1, wherein said warning sign says danger confined space area.

7. A confined space control cover that covers a man-way to a confined space area, comprising:
a base cover with a front, a rear attachment opening and an attachment perimeter orifice that covers said man-way;
a strapping with two ends that is utilized to secure said confined space control cover over said man-way;
a plurality of eyelets that are disposed on said both ends of said strapping;
a warning sign disposed on said front of said base cover to prevent one or more persons from entering said confined space area; and
a maintenance tag that is attached to said strapping to indicate maintenance activity performed near or within said confined space area or said man-way.

8. The control cover according to claim 7, wherein said base cover is made of chemical resistant and breathable fabric.

9. The control cover according to claim 8, wherein said chemical resistant and breathable fabric is made of polyester.

10. The control cover according to claim 7, wherein said strapping is made of heavy nylon material.

11. The control cover according to claim 7, wherein said strapping is placed through said attachment perimeter orifice with said ends being exposed outside said base cover.

12. The control cover according to claim 11, wherein said eyelets accommodate a lock that is utilized to secure said both ends of said strapping around and over said man-way.

13. The control cover according to claim 7, wherein said warning sign is an OSHA sign.

14. The control cover according to claim 7, wherein said warning sign says danger confined space area.

15. A confined space control cover that covers a man-way to a confined space area, comprising:
a polyester base cover with a front, a rear attachment opening and an attachment perimeter orifice that covers said man-way;
a cable and a lock with a proximal end and a distal end that is utilized to secure said confined space control cover over said man-way;
a locking mechanism made of a pair of plastic stops inside of a housing that press firmly against said cable when said locking mechanism is unengaged and a spring that exerts pressure on said pair of stops which allows said cable to lock in place when retracting.;
a warning sign disposed on said front of said base cover to prevent one or more persons from entering said confined space area; and
a maintenance tag that is attached to said cable to indicate maintenance activity performed near or within said confined space area or said man-way.

16. The control cover according to claim 15, wherein said cable is placed through said attachment perimeter orifice with said ends being exposed outside said base cover.

17. The control cover according to claim 15, wherein said lock is a standard lock and key type of lock.

18. The control cover according to claim 15, wherein said locking mechanism is made of metal or plastic.

19. The control cover according to claim 15, wherein said warning sign is an OSHA sign or a confined space area sign.

20. The control cover according to claim 15, wherein said base cover is made of chemical resistant and breathable fabric.
